(19) United States
(12) Patent Application Publication
(10) Pub. No.: US 2004/0016122 A1
(43) Pub. Date: Jan. 29, 2004

(54) Method of manufacturing crankshaft for a hermetic reciprocating compressor

(76) Inventor: Seung-Don Seo, Gwangju-City (KR)

Correspondence Address: LADAS & PARRY, 224 SOUTH MICHIGAN AVENUE, SUITE 1200, CHICAGO, IL, 60604, US

(21) Appl. No.: 10/310,540

(22) Filed: Dec. 5, 2002

(30) Foreign Application Priority Data
Jul. 24, 2002 (KR) 2002-43467

(51) Int. Cl. B23P 17/00

(52) U.S. Cl. 29/888.08

(57) ABSTRACT

A method of manufacturing a crank shaft for a hermetic reciprocating compressor comprises the steps of forming the main shaft portion and a weight balancing member eccentric with respect to the main shaft portion, forming the weight balancing member positioned adjacent an end of the main shaft portion and between the weight balancing member and the crank portion of the crank shaft member, assembling the crank shaft member and the weight balancing member by caulking, and attaching the assembled crank shaft member and weight balancing member by brazing. The crank shaft member includes the main shaft portion and the crank portion eccentric with respect to the main shaft portion as manufactured by cold forming a ferrous pipe or a solid drawn steel tube. The weight balancing member is formed by press processing a ferrous cold-rolled plate. Accordingly, as the crank shaft is formed by a pipe with a hollow center, the weight balancing member is formed by press processing, and these two members are attached by brazing, the number of processing steps can be significantly reduced, for example, by omitting or minimizing unnecessary conventional processing steps such as rough cutting and turning, which are performed for adjusting concentricity. Consequently, a high-strength crank shaft can be manufactured at low cost.

### BACKGROUND OF THE INVENTION

1. Field of the Invention

The present invention relates to a method of manufacturing a crankshaft of a hermetic reciprocating compressor.

2. Description of the Prior Art

As is well-known, hermetic reciprocating compressors have an electrically-driven unit and a compression unit disposed inside a case. The rotating movement of the electrically-driven unit is converted and transferred into the linear reciprocating movement of the compression unit by the crank shaft and accordingly the refrigerant is compressed by the piston of the compression unit cycling through a reciprocating motion within a cylinder.

A typical example of such a conventional hermetic reciprocating compressor is shown in FIG. 1 and described hereinafter.

As shown in FIG. 1, a conventional hermetic reciprocating compressor has an electrically-driven unit 20 and a compression unit 30 disposed inside a case 10 comprising upper and lower shells 1, 2. The electrically-driven unit 20 and the compression unit 30 are connected by a crank shaft 40. The crank shaft 40 converts and transfers the rotating movement of the electrically-driven unit 20 into the linear reciprocating movement needed for operation of the compression unit 30.

The crank shaft 40 comprises a main shaft portion 41 press fit to a rotor 21 of the electrically-driven unit 20, a crank portion 42 connected with a piston 31 of the compression unit 30 by the interposition of a connecting rod 32, and a weight balancing portion 43. In the drawing, the reference number 22 is a stator, 33 is a cylinder block, and 34 is a cylinder head.

A conventional method of manufacturing the crank shaft of the hermetic reciprocating compressor as described above is to cast a crank shaft and then to process the cast to obtain a desired size. In other words, according to the drawings, after casting a crank shaft having the main shaft portion 41, the crank portion 42 eccentric to a certain extent with respect to the main shaft portion 41, and the weight balance portion 43 positioned in between the main shaft portion 41 and the crank portion 42, the cast crank shaft is machined down by processes such as rough cutting and turning to obtain a predetermined or desired size. The crank shaft is then heat processed for increasing its strength and the heated crank shaft is again machined by a finishing process.

However, this method of manufacturing the crank shaft has the problem of low productivity and high manufacturing costs caused by the increase of the number of processing steps because the crank shaft is rough cast and requires many individual processing steps such as rough cutting, turning and polishing.

In addition, as the number of cutting processes increases due to the increase in the casting dispersion, the cycle time increases, thereby causing low productivity. Moreover, processing conditions vary and abrasion of the cutting tools is accelerated as a result of the many differences in the construction and strength of the cast crank shafts.

The conventional method of manufacturing a crank shaft also produces weak end products as it is difficult to produce a crank shaft having a hollow center that still retains its strength. A non-hollow crank shaft lowers the efficiency of the compressor due to the heavy weight of the crank shaft.

Finally, in the conventional method of manufacturing a crank shaft, a relatively deeper oil path has to be formed in the cast during the casting process and completed in a post-processing step. Therefore, productivity significantly drops due to complicated oil path manufacturing processes.

### SUMMARY OF THE INVENTION

An object of the present invention for solving the above-described problems is to provide a method of manufacturing a crank shaft for a hermetic reciprocating compressor which does not require initial cutting steps nor post-processing as, the casting dispersion is stable, and enables improving productivity and reducing manufacturing costs by significantly decreasing or eliminating processing steps such as oil path processing.

Another object of the present invention is to provide a method of manufacturing a crank shaft for a hermetic reciprocating compressor resulting in a light and high-strength crank shaft.

According to the method of manufacturing a crank shaft for a hermetic reciprocating compressor for achieving the above objects, a crank shaft member, having a main shaft portion and a crank portion eccentric with respect to the main shaft portion, and a weight balancing member positioned at an and of the main shaft portion of the crank shaft member, wherein the crank shaft member and the crank portion are individually formed and then attached by brazing.

According to the preferred embodiment of the present invention, a method of manufacturing a crank shaft for a hermetic reciprocating compressor comprises the steps of forming a main shaft portion and a weight balancing member eccentric with respect to the main shaft portion, forming the weight balancing member positioned at an end of the main shaft portion and between the weight balancing member and the crank portion of the crank shaft member, assembling the crank shaft member and the weight balancing member by caulking, and combining the assembled crank shaft member and weight balancing member by brazing.

It is preferable that the crank shaft member has the main shaft portion and the crank portion eccentric with respect to the main shaft portion manufactured by cold forming a ferrous pipe or a solid drawn steel tube. More preferably, the crank shaft member includes an oil hole and an oil groove formed in the crankshaft surface when the main shaft portion and the crank portion are formed, and also a final polishing step.

It is preferable that the weight balancing member is formed by press processing a ferrous cold-rolled plate.

In addition, a step of polishing the outer diameter of the crank shaft member and the side surface of the weight balancing member is included after the step of attaching the assembled crank shaft member and weight balancing member by brazing.

According to the present invention, the crank shaft member is formed by cold forming a ferrous pipe or a solid drawn steel tube and the weight balancing member is formed by press processing a ferrous cold-rolled plate, thereby omitting conventional processing steps, such as rough cutting and turning, for adjusting concentricity and thereby improving productivity and reducing manufacturing costs. Furthermore, since the crank shaft member and the weight balancing member are attached by brazing, a high strength crank shaft is produced that is less likely to deform by heat.

### BRIEF DESCRIPTION OF THE DRAWINGS

The aforementioned objects and characteristic of the present invention will be more apparent by describing a preferred embodiment of the present invention with reference to the accompanying drawings, in which:

FIG. 1 is a perspective exploded partially cut-away view showing a conventional hermetic reciprocating compressor;

FIG. 2 is a flow chart showing a method of manufacturing a hermetic reciprocating crank shaft according to an embodiment of the present invention;

FIG. 3 is a schematic, cross-sectional view showing a crank shaft member and a weight balancing member being caulked by a caulking device using the method of manufacturing a crank shaft according to the present invention;

FIG. 4 is a bottom view of the upper punch of the caulking device shown in FIG. 3; and

FIG. 5 is a perspective view showing a crank shaft of the hermetic reciprocating compressor manufactured according to the present invention.

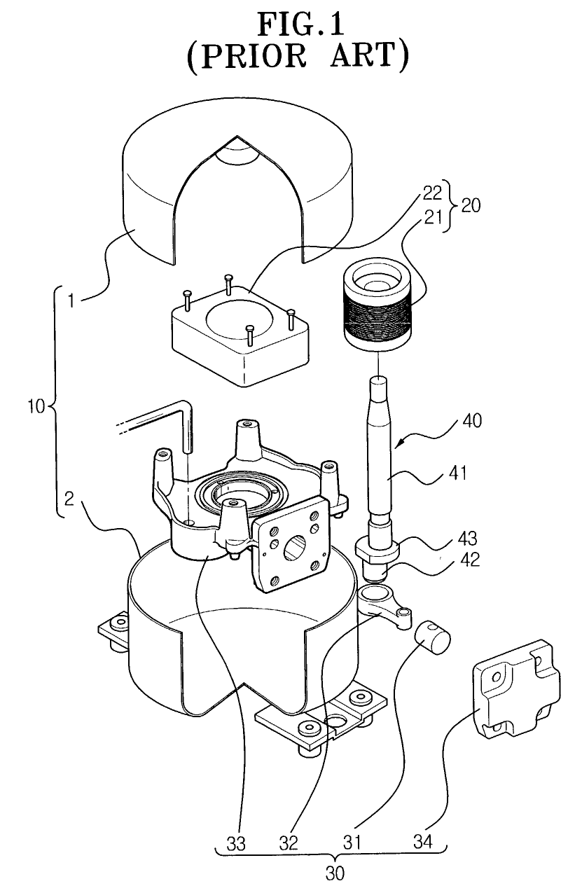

### DETAILED DESCRIPTION OF THE PREFERRED EMBODIMENT

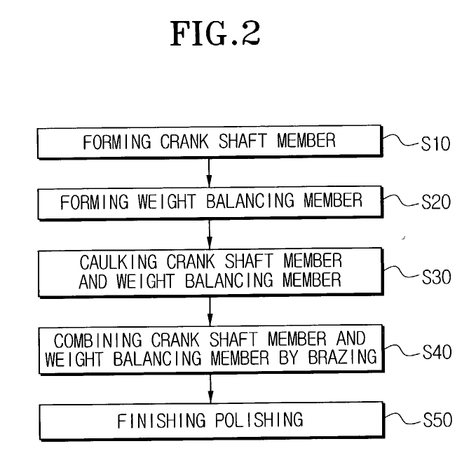

A preferred embodiment of the present invention now will be described in greater detail with reference to the accompanying drawings FIGS. 2-5.

Referring to FIG. 2, a method of manufacturing a crank shaft for a hermetic reciprocating compressor according to an embodiment of the present invention comprises the steps of forming a crank shaft member S10, forming a weight balancing member S20, assembling the crank shaft member and the weight balancing member formed in steps S10 and S20, and connecting the assembled crank shaft member and weight balancing member to each other by brazing S40.

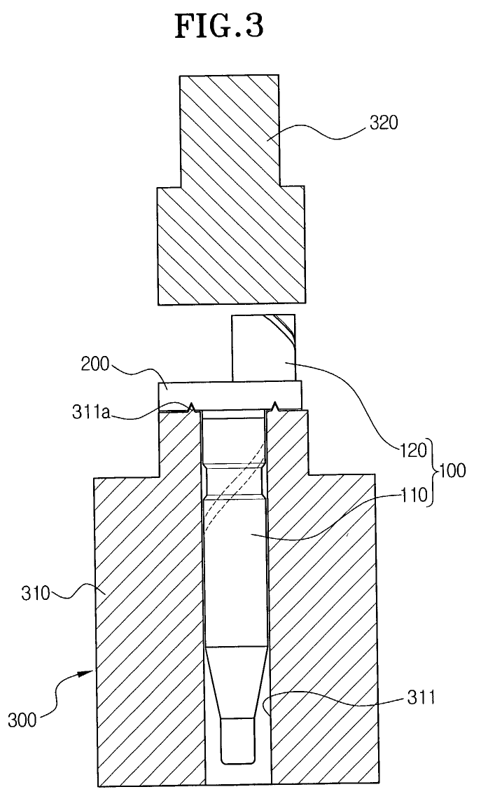

Referring now to FIGS. 3 through 5, the crank shaft member 100 includes a main shaft portion 110 and a crank portion 120, eccentrically disposed with respect to the main shaft portion 110. Crank shaft member 100 may be manufactured by forming the main shaft portion 110 and the crank portion 120 by cold forming a ferrous pipe or a solid drawn steel tube, forming an oil hole 121 and an oil groove 122 on the outer surface thereof, and a final polishing step. The weight balancing member 200 is formed by press processing a ferrous cold-rolled plate.

Accordingly, there is no need of rough cut and turning processes for adjusting concentricity of the crank shaft member, which processes were always performed in the conventional casting method. In addition, because a pipe having a hollow center is used, the oil hole and the oil groove can be very easily formed.

If the crank shaft is formed comprising a hollow pipe, not only the weight can be significantly reduced, compared to a steel pipe, but also the strength can be increased, and almost no post-processing becomes necessary as the casting dispersion becomes more stable, and results in improvement in straightness of the pipe.

Moreover, since the weight balancing member 200 is formed by a pressing process of a plate, high quality processing conditions can be obtained, and therefore unnecessary cutting processes may be omitted. Therefore, a number of finishing process steps can be reduced.

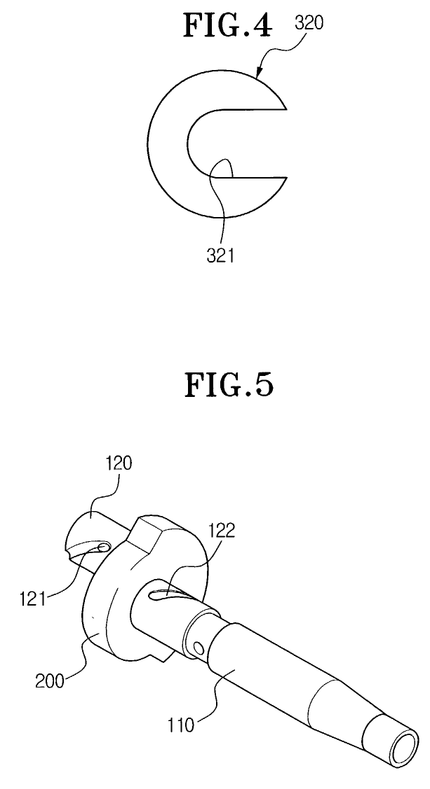

The crank shaft member 100 and the weight balancing member 200 manufactured as above are caulked and assembled in the caulking apparatus 300 as shown in FIG. 3. The caulking apparatus 300 comprises a lower die 310 and an upper punch 320. The lower die 310 comprises a fixing portion 311, into which the main shaft portion 110 of the crank shaft member 100 is received and fixed, and plural wedges 311a protruding around the upper surface of the fixing portion 311. The upper punch 320 comprises a recess 321 (FIG. 4).

The crank shaft member 110 is stationed as its main shaft portion 110 is inserted into the fixing portion 311 of the lower die 311. The weight balancing member 200 is inserted into the crank shaft member 100 for it to be located between the main shaft portion 110 and the crank portion 120. The weight balancing member 200 is positioned so that a lower surface is in contact with the plural wedges 311a of the lower die 310.

When the upper punch 320 is lowered and the weight balancing member 200 is pressed, the weight balancing member 200 is press fit by the wedges 311a in the axial direction of the crank shaft member 100 and the crank shaft member 100 and the weight balancing member 200 are thereby caulked and assembled. The crank shaft member 100 and the weight balancing member 200 are transition fit and it is preferable that the weight balancing member 200 is press fit for a distance of between 1.5 and 2.2 mm in.

The caulked and assembled crank shaft member 100 and weight balancing member 200 are then moved to a brazing furnace and attached completely by brazing. If the two members 100, 200 are attached by brazing, the product strength can be increased and also the residual stress can be removed since the crank shaft member 100 and the weight balancing member 200 are combined by filling melt brass in any intervening gap.

The crank shaft 100 attached by brazing is finally completed by one or more finishing processes. The finishing processes may include polishing the outer diameter of the crank shaft member 100 and the side surface of the weight balancing member 200, as in step (S50) of FIG. 2.

According to the present invention, rough cutting and turning processes performed in the conventional method for adjusting concentricity can be either omitted or replaced by minimum cutting steps, and since the two members are attached by brazing, this process requires processing for a shorter time, and thus productivity may be increased. Additionally, the result is a high strength crank shaft less likely to be deformed by heat.

According to the above described present invention, since the crank shaft is formed by a ferrous pipe or a solid drawn steel tube, not only the weight can be reduced but also post-processing becomes unnecessary as the cast dispersion is stable. In addition, because the weight balancing member is formed by press processing, almost no post-processing becomes necessary and therefore, the number of processing steps, such as cutting, can be significantly reduced. Accordingly, productivity can be improved and manufacturing costs can be reduced.

Moreover, according to the present invention, as the crank shaft member and the weight balancing member are attached by brazing, a high strength crank shaft, that is less likely to be deformed by heat, can be manufactured.

Furthermore, because the crank shaft is formed in the shape of a pipe, the process of forming an oil path simply requires forming an oil hole in the radial direction of the main shaft portion, and therefore the manufacturing process can be significantly simplified compared to the conventional deep oil path forming process.

Although the preferred embodiment of the present invention has been described, it will be understood by those skilled in the art that the present invention should not be limited to the described preferred embodiment. Various changes and modifications can be made while remaining within the sprit and scope of the present invention as defined by the appended claims.

What is claimed is:

1. A method of manufacturing a crank shaft for a hermetic reciprocating compressor, wherein a crank shaft member having a main shaft portion and a crank portion eccentric with respect to the main shaft portion, and a weight balancing member positioned adjacent an end of the main shaft portion of the crank shaft member and the crank portion, are each individually formed and then attached by brazing.

2. The method of manufacturing a crank shaft for a hermetic reciprocating compressor as in claim 1, wherein the crank shaft member, including the main shaft portion and the crank portion eccentric with respect to the main shaft portion, are manufactured by cold forming a ferrous pipe or a solid drawn steel tube.

3. The method of manufacturing a crank shaft for a hermetic reciprocating compressor as in claim 2, wherein an oil hole and an oil groove are formed in the forming step of the main shaft portion and the crank portion of the crank shaft member.

4. The method of manufacturing a crank shaft for a hermetic reciprocating compressor as in claim 1, wherein the weight balancing member is formed by press processing a ferrous cold-rolled plate.

5. A method of manufacturing a crank shaft for a hermetic reciprocating compressor, comprising steps of:
a) forming a main shaft portion and a weight balancing member eccentric with respect to the main shaft portion;
b) forming the weight balancing member positioned adjacent an end of the main shaft portion and the balancing member being disposed between the main shaft portion and the crank portion of the crank shaft member;
c) assembling the crank shaft member and the weight balancing member by caulking; and
d) attaching the assembled crank shaft member to the weight balancing member by brazing.

6. The method of manufacturing a crank shaft for a hermetic reciprocating compressor as in claim 5, wherein the crank shaft member, including the main shaft portion and the crank portion eccentric with respect to the main shaft portion, are manufactured by cold forming a ferrous pipe or a solid drawn steel tube.

7. The method of manufacturing a crank shaft for a hermetic reciprocating compressor as in claim 6, wherein an oil hole and an oil groove are formed in the forming step of the main shaft portion and the crank portion of the crank shaft member.

8. The method of manufacturing a crank shaft for a hermetic reciprocating compressor as in claim 5, wherein the weight balancing member is formed by press processing a ferrous cold-rolled plate.

9. The method of manufacturing a crank shaft for a hermetic reciprocating compressor as in claim 5, further comprising e) a step of polishing the outer diameter of the crank shaft member and the side surface of the weight balancing member after step d).
